(19) United States
(12) Patent Application Publication
(10) Pub. No.: US 2026/0217593 A1
(43) Pub. Date: Jul. 30, 2026

(54) INORGANIC COMPOSITION ARTICLE

(71) Applicant: OHARA INC., SAGAMIHARA-SHI, KANAGAWA (JP)

(72) Inventors: KOHEI OGASAWARA, SAGAMIHARA-SHI, KANAGAWA (JP); SAYA KIKKAWA, SAGAMIHARA-SHI, KANAGAWA (JP); TOSHITAKA YAGI, SAGAMIHARA-SHI, KANAGAWA (JP)

(21) Appl. No.: 19/144,511

(22) PCT Filed: Dec. 21, 2023
(86) PCT No.: PCT/JP2023/046021

§ 371 Date: Jun. 30, 2025

(30) Foreign Application Priority Data
Dec. 28, 2022 (JP) 2022-212558

(51) Int. Cl. C03C 10/00; C03C 21/00

(52) U.S. Cl. CPC C03C 10/0009; C03C 21/002

(57) ABSTRACT

Provided is an inorganic composition article which contains, as a main crystal phase, at least one selected from an α-cristobalite and an α-cristobalite solid solution, and is obtained by strengthening crystallized glass containing, in terms of oxide mass %, 50.0%-75.0% of SiO₂, 3.0%-10.0% of Li₂O, 5.0% to 15.0% (exclusive of 15.0%) of Al₂O₃, 0% to 10.0% (exclusive of 0%) of B₂O₃, and 0% to 10.0% (exclusive of 0%) of P₂O₅, wherein a mass ratio SiO₂/(B₂O₃+Li₂O) is 3.0-10.0. A thickness (DOLzero) of a compressive stress layer on a surface is 8.0%-25.0% of a plate thickness of the inorganic composition article, and a center tensile stress (CT) is 70 MPa-120 MPa.

### FIELD OF THE DISCLOSURE

The present invention relates to an inorganic composition article related to strengthened crystallized glass having a compressive stress layer on a surface thereof.

Various types of glass are expected to be used as a cover glass or a housing for protecting a display of a portable electronic device such as a smartphone or a tablet PC, a protector for protecting a lens of an in-vehicle optical device, an interior bezel, a console panel, a touch panel material, a smart key, and the like. These devices are required to be used in a harsh environment, and there is an increasing demand for glass having a higher strength.

Conventionally, chemically strengthened glass is employed as a material for use in a protective member and the like. However, there are many cases where a conventional chemically strengthened glass breaks when a portable device such as a smartphone is dropped, resulting in a problem. In particular, there is a demand for crystallized glass that is less likely to break when dropped onto a rough, uneven surface such as asphalt.

When a central tensile stress (CT [MPa]) is high, broken pieces of glass are small when the glass is broken, and there is a tendency for the glass to be broken into small pieces. In the case of using glass for use in a protective member and the like, the glass surface may be polished and used, but when the glass surface is polished, the CT is lowered, and thus it is necessary to increase the CT of the glass before polishing. However, when there is no polishing step, the CT is too high, and thus there is a problem in that broken pieces of glass are too small when the glass is broken, and the glass is broken into small pieces. The thickness (DOLzero [μm]) of a compressive stress layer affects the difficulty of cracking of the glass and the size of broken pieces when the glass is broken. Therefore, there has been a demand for glass having a certain thickness (DOLzero) of a compressive stress layer without an excessively high CT, which can cope with a case where there is no polishing step.

Patent Literature 1 discloses a material composition of a crystallized glass substrate for an information recording medium that can be chemically strengthened. It is described that an α-cristobalite-based crystallized glass described in Patent Literature 1 can be chemically strengthened and can be used as a high-strength material substrate. However, crystallized glass for an information recording medium represented by a substrate for a hard disk is not intended for use in a harsh environment.

### CITATION LIST

### Patent Literature

Patent Literature 1: JP 2008-254984 A

### SUMMARY OF THE DISCLOSURE

An object of the present invention is to provide an inorganic composition article related to strengthened crystallized glass that is less likely to break when dropped onto a rough surface. Another object of the present invention is to provide an inorganic composition article related to strengthened crystallized glass having a certain thickness (DOLzero) of a compressive stress layer without an excessively high central tensile stress (CT).

The present invention provides the following.

### (Configuration 1)

An inorganic composition article comprising,
as a main crystal phase, one or more selected from α-cristobalite and an α-cristobalite solid solution, wherein,
the inorganic composition article is obtained by strengthening a crystallized glass,
a thickness (DOLzero) of a compressive stress layer on the surface is 8.0% to 25.0% of a sheet thickness of the inorganic composition article,
a central tensile stress (CT) is 70 MPa to 120 MPa, and
in the crystallized glass, in mass % in terms of oxides,
a content of a SiO₂ component is 50.0% to 75.0%,
a content of a Li₂O component is 3.0% to 10.0%,
a content of an Al₂O₃ component is 5.0% or more and less than 15.0%,
a content of a B₂O₃ component is more than 0% and 10.0% or less,
a content of a P₂O₅ component is more than 0% and 10.0% or less, and
a mass ratio SiO₂/(B₂O₃+Li₂O) is 3.0 to 10.0.

### (Configuration 2)

An inorganic composition article comprising,
as a main crystal phase, one or more selected from α-cristobalite and an α-cristobalite solid solution, wherein,
the inorganic composition article is obtained by strengthening a crystallized glass,
a thickness (DOLzero) of a compressive stress layer on the surface is 8.0 μm to 500 μm,
a central tensile stress (CT) is 70 MPa to 120 MPa, and
in the crystallized glass, in mass % in terms of oxides,
a content of a SiO₂ component is 50.0% to 75.0%,
a content of a Li₂O component is 3.0% to 10.0%,
a content of an Al₂O₃ component is 5.0% or more and less than 15.0%,
a content of a B₂O₃ component is more than 0% and 10.0% or less,
a content of a P₂O₅ component is more than 0% and 10.0% or less, and
a mass ratio SiO₂/(B₂O₃+Li₂O) is 3.0 to 10.0.

### (Configuration 3)

The inorganic composition article according to Configuration 1 or 2, wherein
in the crystallized glass, in mass % in terms of oxides,
a content of a ZrO₂ component is more than 0% and 10.0% or less, and
a total content of the Al₂O₃ component and the ZrO₂ component is 10.0% or more.

### (Configuration 4)

The inorganic composition article according to any one of Configurations 1 to 3, wherein
in the crystallized glass, in mass % in terms of oxides,
a content of a K₂O component is 0% to 5.0%.

### (Configuration 5)

The inorganic composition article according to any one of Configurations 1 to 4, wherein
in the crystallized glass, in mass % in terms of oxides,
a content of a Na₂O component is 0% to 4.0%,
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

### (Configuration 6)

The inorganic composition article according to any one of Configurations 1 to 5, wherein
in the crystallized glass, in mass % in terms of oxides,
a content of a Nb₂O₅ component is 0% to 5.0%,
a content of a Ta₂O₅ component is 0% to 6.0%, and
a content of a TiO₂ component is 0% or more and less than 1.0%.

### (Configuration 7)

The inorganic composition article according to any one of Configurations 1 to 6, wherein
a glass transition temperature (Tg) of glass before crystallization of the crystallized glass is 610° C. or lower.

### (Configuration 8)

The inorganic composition article according to any one of Configurations 1 to 7, wherein the sheet thickness of the inorganic composition article is 0.1 mm to 2.0 mm.

According to the present invention, by controlling the amount of LiO₂ and adjusting the amount of SiO₂ and the amount of Al₂O₃, it is easy to produce an inorganic composition article related to a strengthened crystallized glass that is less likely to break when dropped onto a rough surface, and it is possible to stably produce the inorganic composition article. According to the present invention, it is possible to provide an inorganic composition article having a certain compressive stress layer thickness (DOLzero) without an excessively high central tensile stress (CT).

The “inorganic composition article” in the present invention is composed of an inorganic composition material such as glass, crystallized glass, ceramics, or a composite material thereof. The “article” of the present invention corresponds to, for example, an article obtained by molding these inorganic materials into a desired shape by processing, synthesis by a chemical reaction, or the like. A green compact obtained by pulverizing and then pressurizing an inorganic material, a sintered body obtained by sintering the green compact, and the like are also applicable. The shape of the article obtained here is not limited by smoothness, curvature, size, and the like. Examples thereof include a plate-like substrate, a molded body having a curvature, and a three-dimensional structure having a complicated shape. One obtained by chemically strengthening an inorganic composition material also corresponds to the article.

The inorganic composition article of the present invention is a glass-based material having a high strength and processability, and can be used as a protective member of equipment or the like. It can be used as a member of a cover glass or a housing of a smartphone, a portable electronic device such as a tablet PC or a wearable terminal, or can be used as a member of a protective protector or a substrate for a head-up display used in a transport body such as a car or an airplane. The present invention can be used for other electronic devices, machinery and equipment, a building member, a member for a solar panel, a member for a projector, a cover glass (windshield) for glasses or a watch, and the like.

### DETAILED DESCRIPTION OF THE EXEMPLARY EMBODIMENTS

Hereinafter, embodiments and examples of an inorganic composition article of the present invention will be described in detail, but the present invention is not limited to the following embodiments and examples, and can be implemented with appropriate modifications within the scope of the object of the present invention.

The inorganic composition article of the present invention and crystallized glass as a base material thereof contain one or more selected from α-cristobalite and an α-cristobalite solid solution as a main crystal phase. Crystallized glass precipitating these crystal phases has a high mechanical strength.

Here, the “main crystal phase” in the present specification corresponds to a crystal phase contained most in the crystallized glass determined from a peak of an X-ray diffraction pattern.

In the present specification, contents of respective components are all expressed in mass % in terms of oxides unless otherwise specified. Here, the expression “in terms of oxides” refers to the amount of oxides of each component included in the crystallized glass expressed in mass % when the total mass of oxides is 100 mass % assuming that all the glass constituent components of the crystallized glass are decomposed and converted to oxides. In the present specification, A % to B % represent A % or more and B % or less.

Hereinafter, an inorganic composition article according to a first embodiment of the present invention will be described.

In strengthened crystallized glass and crystallized glass as a base material thereof of the inorganic composition article according to the first embodiment of the present invention,
in mass % in terms of oxides,
a content of a SiO₂ component is 50.0% to 75.0%,
a content of a Li₂O component is 3.0% to 10.0%,
a content of an Al₂O₃ component is 5.0% or more and less than 15.0%,
a content of a B₂O₃ component is more than 0% and 10.0% or less,
a content of a P₂O₅ component is more than 0% and 10.0% or less, and
a mass ratio SiO₂/(B₂O₃+Li₂O) is 3.0 to 10.0.

By having the main crystal phase and the composition described above, the crystallized glass has a low glass transition temperature, the melting property of the raw material is enhanced, it is easy to produce the crystallized glass, and the obtained crystallized glass is easily processed by 3D processing or the like.

Hereinafter, the composition ranges of the respective components constituting the crystallized glass as a base material of the inorganic composition article of the present invention will be described.

The SiO₂ component is an essential component necessary for constituting one or more selected from α-cristobalite and an α-cristobalite solid solution. When the content of the SiO₂ component is 75.0% or less, an excessive increase in viscosity and deterioration of melting property can be suppressed, and when the content is 50.0% or more, deterioration of devitrification can be suppressed.

The upper limit is preferably set to 74.0% or less, 73.0% or less, 72.0% or less, or 70.0% or less. The lower limit is preferably set to 55.0% or more, 58.0% or more, or 60.0% or more.

The Li₂O component is a component that improves the meltability of raw glass, but when the amount thereof is 3.0% or more, an effect of improving the meltability of the raw glass can be obtained, and when the amount is 10.0% or less, an increase in production of lithium disilicate crystals can be suppressed. The Li₂O component is a component involved in chemical strengthening.

The lower limit is preferably set to 3.5% or more, 4.0% or more, 4.5% or more, 5.0% or more, or 5.5% or more. The upper limit is preferably set to 9.0% or less, 8.5% or less, or 8.0% or less.

The Al₂O₃ component is a component suitable for improving the mechanical strength of the crystallized glass. When the content of the Al₂O₃ component is set to less than 15.0%, deterioration of melting property and devitrification can be suppressed, and when the content is set to 5.0% or more, a decrease in mechanical strength can be suppressed.

The upper limit is preferably set to 14.5% or less, 14.0% or less, 13.5% or less, or 13.0% or less. The lower limit can be preferably set to 5.5% or more, 5.8% or more, 6.0% or more, 6.5% or more, or 8.0% or more.

The B₂O₃ component is a component suitable for lowering the glass transition temperature of the crystallized glass, but when the amount thereof is set to 10.0% or less, a decrease in chemical durability can be suppressed.

The upper limit is preferably set to 8.0% or less, 7.0% or less, 5.0% or less, or 4.0% or less. The lower limit is more than 0%, and preferably set to 0.001% or more, 0.01% or more, 0.05% or more, 0.10% or more, or 0.30% or more.

The ZrO₂ component is a component that can improve the mechanical strength, but when the amount thereof is 10.0% or less, deterioration of melting property can be suppressed.

The upper limit is preferably set to 10.0% or less, 9.0% or less, 8.5% or less, or 8.0% or less. The lower limit can be preferably set to more than 0%, 1.0% or more, 1.5% or more, or 2.0% or more.

When [Al₂O₃+ZrO₂], which is the sum of the contents of the Al₂O₃ component and the ZrO₂ component, is large, the compressive stress on the surface increases at the time of strengthening. The lower limit of [Al₂O₃+ZrO₂] is preferably set to 10.0% or more, 11.0% or more, 12.0% or more, or 13.0% or more.

On the other hand, when the content is set to 22.0% or less, deterioration of melting property can be suppressed. Therefore, the upper limit of [Al₂O₃+ZrO₂] is preferably set to 22.0% or less, 21.0% or less, 20.0% or less, or 19.0% or less.

The mass ratio SiO₂/(B₂O₃+Li₂O) is 3.0 to 10.0. By setting the mass ratio to 3.0 to 10.0, it is possible to contribute to lowering the viscosity of the glass, to facilitate the production of the glass, and to increase the amount of alkali ions to be ion-exchanged at the time of chemical strengthening, thereby producing strengthened crystallized glass having a desired CS30 (compressive stress at a depth of 30 μm from the outermost surface).

Therefore, the lower limit of the mass ratio SiO₂/(B₂O₃+Li₂O) is set to preferably 3.5 or more, and more preferably 4.64 or more. The upper limit of the mass ratio SiO₂/(B₂O₃+Li₂O) is set to preferably 9.5 or less and still more preferably less than 8.6.

When [SiO₂+Li₂O+Al₂O₃+B₂O₃], which is the sum of the contents of the SiO₂ component, the Li₂O component, the Al₂O₃ component, and the B₂O₃ component is large, glass which is easily chemically strengthened and has a high strength can be obtained. Therefore, the lower limit of [SiO₂+Li₂O+Al₂O₃+B₂O₃] is set to 75.0% or more, 77.0% or more, 79.0% or more, 80.0% or more, 83.0% or more, or 85.0% or more. The upper limit is not particularly limited, but can be set to, for example, less than 100% or 99% or less.

The P₂O₅ component is an essential component that can be added to act as a crystal nucleating agent for glass. By setting the amount of the P₂O₅ component to 10.0% or less, deterioration of devitrification of glass and phase separation of glass can be suppressed.

The upper limit is preferably set to 8.0% or less, 6.0% or less, 5.0% or less, or 4.0% or less. The lower limit is more than 0%, and can be set to, for example, 0.5% or more, 1.0% or more, or 1.5% or more.

The K₂O component is an optional component involved in chemical strengthening when contained in an amount of more than 0%. The lower limit of the K₂O component can be set to 0% or more, more than 0%, 0.1% or more, 0.3% or more, or 0.5% or more.

By setting the content of the K₂O component to 5.0% or less, precipitation of crystals can be promoted. Therefore, the upper limit of the K₂O component can be preferably set to 5.0% or less, 4.0% or less, 3.5% or less, or 3.0% or less.

The Na₂O component is an optional component involved in chemical strengthening when contained in an amount of more than 0%. By setting the content of the Na₂O component to 4.0% or less, a desired crystal phase can be easily obtained. The upper limit of the Na₂O component is preferably 4.0% or less or 3.5% or less, more preferably 3.0% or less, and still more preferably 2.5% or less. The lower limit of the Na₂O component can be set to 0% or more.

Each of the MgO component, the CaO component, the SrO component, the BaO component, and the ZnO component is an optional component that improves low-temperature meltability when contained in an amount of more than 0%, and can be contained as long as the exceeding of the present invention is not impaired.

Therefore, the upper limit of the MgO component can be preferably set to 4.0% or less, 3.5% or less, 3.0% or less, or 2.5% or less. The lower limit of the MgO component can be preferably set to 0% or more, more than 0%, 0.3% or more, or 0.4% or more.

The upper limit of the CaO component can be preferably set to 4.0% or less, 3.0% or less, 2.5% or less, or 2.0% or less. The lower limit of the CaO component can be set to 0% or more.

The upper limit of the SrO component can be preferably set to 4.0% or less, 3.0% or less, 2.5% or less, or 2.0% or less. The lower limit of the SrO component can be set to 0% or more.

The upper limit of the BaO component can be preferably set to 5.0% or less, 4.0% or less, 3.0% or less, 2.5% or less, or 2.0% or less. The lower limit of the BaO component can be set to 0% or more.

The upper limit of the ZnO component can be preferably set to 10.0% or less, 9.0% or less, 8.5% or less, 8.0% or less, or 7.5% or less. The lower limit of the ZnO component can be preferably set to 0% or more, more than 0%, 0.5% or more, or 1.0% or more.

The crystallized glass may or may not contain the Nb₂O₅ component, the Ta₂O₅ component, and the TiO₂ component as long as the effect of the present invention is not impaired.

The Nb₂O₅ component is an optional component that improves the mechanical strength of the crystallized glass when contained in an amount of more than 0%. The upper limit can be preferably set to 5.0% or less, 4.0% or less, 3.5% or less, or 3.0% or less. The lower limit of the Nb₂O₅ component can be set to 0% or more.

The Ta₂O₅ component is an optional component that improves the mechanical strength of the crystallized glass when contained in an amount of more than 0%. The upper limit can be preferably set to 6.0% or less, 5.5% or less, 5.0% or less, or 4.0% or less. The lower limit of the Ta₂O₅ component can be set to 0% or more.

The TiO₂ component is an optional component that improves the chemical durability of the crystallized glass when contained in an amount of more than 0%. The upper limit can be preferably set to less than 1.0%, 0.8% or less, 0.5% or less, or 0.1% or less. The lower limit of the TiO₂ component can be set to 0% or more.

The crystallized glass may or may not contain a La₂O₃ component, a Gd₂O₃ component, a Y₂O₃ component, a WO₃ component, a TeO₂ component, and a Bi₂O₃ component as long as the effect of the present invention is not impaired. The blending amount of each component can be set to 0% to 2.0%, 0% to less than 2.0%, or 0% to 1.0%.

The crystallized glass may or may not further contain other components not described above as long as the properties of the crystallized glass of the present invention are not impaired. Examples thereof include metal components (including metal oxides thereof) such as Yb, Lu, V, Cr, Mn, Fe, Co, Ni, Cu, Ag, and Mo.

A Sb₂O₃ component may be contained as a clarifying agent for glass. By setting the content of the Sb₂O₃ component to 3.0% or less, it is possible to suppress deterioration of transmittance in a short wavelength region of a visible light region. Therefore, the upper limit can be set to preferably 3.0% or less, more preferably 2.0% or less, still more preferably 1.0% or less, and still further preferably 0.6% or less. The lower limit of the Sb₂O₃ component can be set to 0% or more.

Also, a SnO₂ component, a CeO₂ component, an As₂O₃ component, and one or more selected from the group consisting of F, NOx, and SOx may or may not be included in addition to the Sb₂O₃ component as a glass clarifying agent. The upper limit of the content of the clarifying agent can be set to preferably 2.0% or less, more preferably 1.0% or less, and most preferably 0.6% or less.

Meanwhile, since each component of Pb, Th, Tl, Os, Be, Cl, and Se tends to be refrained from being used as they are harmful chemical substances in recent years, it is preferable that these components are not substantially included.

The compressive stress (CS [MPa]) of the compressive stress layer of the inorganic composition article is preferably 550 MPa or more, more preferably 600 MPa or more, and still more preferably 700 MPa or more. The upper limit is, for example, 1400 MPa or less, 1300 MPa or less, 1200 MPa or less, or 1100 MPa or less. By having such a compressive stress value, the development of cracks can be suppressed and the mechanical strength can be enhanced.

The central tensile stress (CT [MPa]) is an index of the degree of strengthening of glass by chemical strengthening. When the CT value is high, broken pieces when the glass is broken are small, and there is a tendency for the glass to be broken into small pieces. Therefore, for the impact resistance of the glass, the central tensile stress (CT [MPa]) is 70 MPa or more, preferably 75 MPa or more, more preferably 80 MPa or more, and still more preferably 85 MPa or more. The upper limit is 120 MPa or less, and preferably 115 MPa or less or 110 MPa or less. By having such a central tensile stress, desired strengthened crystallized glass by chemical strengthening can be obtained.

The thickness (DOLzero [μm]) of the compressive stress layer on the surface, which also depends on the thickness of the inorganic composition article, can be set to 8.0 μm to 500 μm. The thickness can be set to more preferably 9.5 μm to 440 μm, more preferably 20 μm to 400 μm, more preferably 30 μm to 350 μm, more preferably 50 μm to 300 μm, and still more preferably 60 to 120 μm. In the following description, the “thickness of the compressive stress layer on the surface” may be simply referred to as the “thickness of the compressive stress layer”. For example, when the sheet thickness of the inorganic composition article is 0.1 mm, DOLzero can be set to 8.0 to 25 μm. When the sheet thickness of the inorganic composition article is 0.1 mm, the upper limit of DOLzero can be set to, for example, 25 μm or less, 22 μm or less, or 20 μm or less. When the sheet thickness of the inorganic composition article is 0.1 mm, the lower limit of DOLzero can be set to, for example, 8.0 μm or more, 8.5 μm or more, or 9.5 μm or more. When the sheet thickness of the inorganic composition article is 2.0 mm, DOLzero can be set to 160 to 500 μm. When the sheet thickness of the inorganic composition article is 2.0 mm, the upper limit of DOLzero can be set to, for example, 440 μm or less, 420 μm or less, or 400 μm or less.

When the sheet thickness of the inorganic composition article is 2.0 mm, the lower limit of DOLzero can be set to, for example, 120 μm or more, 160 μm or more, or 180 μm or more.

The lower limit of the thickness (DOLzero) of the compressive stress layer is 8.0% or more, preferably 9.0% or more, more preferably 9.5% or more, more preferably 10% or more, and still more preferably 15% or more, with respect to the sheet thickness of the inorganic composition article. The upper limit of the thickness (DOLzero) of the compressive stress layer is 25.0% or less, preferably 22.0% or less, and more preferably 20.0% or less, with respect to the sheet thickness of the inorganic composition article.

When the crystallized glass related to the inorganic composition article is used as a substrate, the lower limit of the thickness (sheet thickness) of the substrate is preferably 0.1 mm or more, more preferably 0.3 mm or more, more preferably 0.4 mm or more, and still more preferably 0.5 mm or more, and the upper limit is preferably 2.0 mm or less, more preferably 1.5 mm or less, more preferably 1.1 mm or less, more preferably 1.0 mm or less, more preferably 0.9 mm or less, and still more preferably 0.8 mm or less.

Here, the “sheet thickness of the inorganic composition article” refers to a distance between two opposing principal surfaces disposed substantially in parallel when the shape of the inorganic composition article is a plate shape having a finite thickness. For example, the sheet thickness refers to a distance between two substantially rectangular planes when the shape is a strip shape having a finite thickness.

Hereinafter, an inorganic composition article according to a second embodiment of the present invention will be described.

In the inorganic composition article according to the second embodiment of the present invention, the thickness (DOLzero [μm]) of the compressive stress layer on the surface is 8.0 μm to 500 μm.

The thickness (DOLzero [μm]) of the compressive stress layer on the surface of the inorganic composition article according to the second embodiment is preferably 9.5 μm to 440 μm, more preferably 20 μm to 400 μm, more preferably 30 μm to 350 μm, more preferably 50 μm to 300 μm, and still more preferably 60 to 120 μm.

In the inorganic composition article according to the second embodiment of the present invention, the lower limit of the thickness (DOLzero) of the compressive stress layer is preferably 8.0% or more, more preferably 9.0% or more, more preferably 9.5% or more, more preferably 10% or more, and still more preferably 15% or more, with respect to the sheet thickness of the inorganic composition article. The upper limit of the thickness (DOLzero) of the compressive stress layer is set to preferably 25.0% or less, more preferably 22.0% or less, and more preferably 20.0% or less, with respect to the sheet thickness of the inorganic composition article.

The inorganic composition article according to the second embodiment of the present invention has the same properties as in the inorganic composition article according to the first embodiment of the present invention, except for the points described above. The essential composition range and the preferred composition range of the strengthened crystallized glass and the crystallized glass as a base material thereof of the inorganic composition article according to the second embodiment of the present invention are the same as the essential composition range and the preferred composition range of the strengthened crystallized glass and the crystallized glass as a base material thereof of the inorganic composition article according to the first embodiment.

The crystallized glass of the inorganic composition article according to the first embodiment and the inorganic composition article according to the second embodiment of the present invention (in the following description, simply referred to as “inorganic composition article of the present invention”) (in the following description, simply referred to as “crystallized glass”) can be produced by the following method. That is, raw materials are uniformly mixed so that the content of each component falls within a predetermined range, and melted to produce a raw glass. Next, the raw glass is crystallized to produce crystallized glass.

The glass transition temperature (Tg) of glass before crystallization of the crystallized glass is preferably 610° C. or lower, more preferably 600° C. or lower, and still more preferably 590° C. or lower.

A heat treatment for crystal precipitation may be performed at a one-stage temperature or a two-stage temperature.

In a two-stage heat treatment, first, a nucleation step is performed by performing a heat treatment at a first temperature, and after the nucleation step, a crystal growth step is performed by performing a heat treatment at a second temperature higher than that of the nucleation step.

The first temperature of the two-stage heat treatment can be set to preferably 450° C. to 750° C., more preferably 500° C. to 720° C., and still more preferably 550° C. to 680° C. The retention time at the first temperature is preferably 30 minutes to 2000 minutes, and more preferably 180 minutes to 1440 minutes.

The second temperature of the two-stage heat treatment can be set to preferably 550° C. to 850° C., and more preferably 600° C. to 800° C. The retention time at the second temperature is preferably 30 minutes to 600 minutes, and more preferably 60 minutes to 400 minutes.

In a one-stage heat treatment, a nucleation step and a crystal growth step are continuously performed at a one-stage temperature. Usually, the temperature is raised to a predetermined heat treatment temperature, and after reaching the heat treatment temperature, the temperature is maintained for a certain period of time, and then the temperature is lowered.

In the case of performing the one-stage heat treatment, the temperature of the heat treatment is preferably 600° C. to 800° C. and more preferably 630° C. to 770° C. The retention time at the temperature of the heat treatment is preferably 30 minutes to 500 minutes, and more preferably 60 minutes to 400 minutes.

Examples of a method for forming a compressive stress layer in the inorganic composition article include a chemical strengthening method in which an alkali component present in a surface layer of crystallized glass is subjected to an exchange reaction with an alkali component having an ionic radius larger than that of the alkali component of the surface layer to form a compressive stress layer on the surface layer. There are a thermal strengthening method in which crystallized glass is heated and then rapidly cooled, and an ion implantation method in which ions are implanted into a surface layer of crystallized glass.

The inorganic composition article of the present invention can be produced, for example, by the following chemical strengthening method.

Crystallized glass is brought into contact with or immersed in a salt containing potassium, sodium, and lithium, for example, a mixed salt of potassium nitrate (KNO₃), sodium nitrate (NaNO₃), lithium nitrate (LiNO₃), or a molten salt of a composite salt. The treatment of contacting with or immersing in the molten salt may be performed in one stage or in two stages.

In the case of a two-stage treatment, for example, first, crystallized glass is brought into contact with or immersed in a mixed salt of potassium and sodium or a mixed salt of potassium, sodium, and lithium heated at 350° C. to 550° C. for 1 to 1440 minutes, preferably 15 to 500 minutes, and more preferably 30 to 300 minutes. Subsequently, secondly, the crystallized glass is brought into contact with or immersed in a potassium salt, a mixed salt of potassium and sodium, a mixed salt of potassium and lithium, or a mixed salt of potassium, sodium, and lithium heated at 350° C. to 550° C. for 1 to 1440 minutes, and preferably 60 to 600 minutes.

In the case of the two-stage treatment, for example, it is desirable that the first stage treatment is a single bath or a mixed bath of potassium (KNO₃), sodium (NaNO₃), or lithium (LiNO₃), and the second stage treatment is a mixed salt of potassium nitrate (KNO₃), sodium nitrate (NaNO₃), and lithium nitrate (LiNO₃), or a molten salt of a composite salt.

In the case of a one-stage chemical strengthening treatment, for example, crystallized glass is brought into contact with or immersed in a mixed salt containing potassium and sodium, a mixed salt containing potassium, sodium, and lithium, a mixed salt containing sodium, or a mixed salt containing sodium and lithium (mixed salt containing potassium and/or sodium and/or lithium) heated at 350° C. to 550° C. for 1 to 1440 minutes, and preferably 30 to 500 minutes.

### EXAMPLES

### Example 1 and Comparative Examples 1 and 2

### 1. Production of Inorganic Composition Article

As raw materials of respective components of crystallized glass, raw materials of oxides, hydroxides, carbonates, nitrates, fluorides, chlorides, meta-phosphoric acid compounds, or the like corresponding thereto were selected, and these raw materials were weighed so as to have the composition described in Table 1 and uniformly mixed.

Next, the mixed raw materials were put into a platinum crucible and melted at 1300° C. to 1600° C. for 2 to 24 hours in an electric furnace. Thereafter, the molten glass was stirred to be homogenized, the temperature was lowered to 1000° C. to 1450° C., and the glass was then cast into a mold and slowly cooled to produce a raw glass. The obtained raw glass was heated under the crystallization conditions of the nucleation step and the crystal growth step described in Table 1 to produce crystallized glass.

The crystal phase of the crystallized glass was determined from an angle of a peak appearing in an X-ray diffraction pattern using an X-ray diffraction analyzer (manufactured by Bruker, D8 Discover). When the X-ray diffraction pattern of the crystallized glass of Example 1 was checked, since a peak was observed at a position corresponding to the peak pattern of α-cristobalite and/or an α-cristobalite solid solution, it was determined that the α-cristobalite and/or the α-cristobalite solid solution was precipitated as a main crystal phase. When the X-ray diffraction pattern of the crystallized glass of Comparative Example 1 was checked, since a peak of α-cristobalite was not observed, and peaks were observed at positions corresponding to the peak patterns of Li₂Si₂O₅ and α-quartz, and thus the Li₂Si₂O₅ and the α-quartz were determined to be the main crystal phases. In Comparative Example 2, since peaks of α-cristobalite and an α-cristobalite solid solution were not confirmed by an X-ray diffraction analyzer (“D8 Discover” manufactured by Bruker), the crystal phase was checked by analysis by EDX after confirmation by a lattice image based on an electron diffraction image. As a result, it was confirmed that the crystal phases of the glass of Comparative Example 2 were MgAl₂O₄ and MgTi₂O₄.

The glass transition point (Tg) of the glass before crystallization of Example 1 was measured according to Japan Optical Glass Industry Association Standard JOGIS08-2019 “Measuring Method for Thermal Expansion of Optical Glass”.

The crystallized glass produced in each of Example 1 and Comparative Examples 1 and 2 was cut and ground, and opposing sides of the resultant crystallized glass were further polished in parallel so as to have the sheet thickness (thickness) shown in Tables 2 to 6, thereby obtaining a crystallized glass substrate.

A chemically strengthened crystallized glass substrate was obtained using this crystallized glass substrate as a base material.

In Examples 1-1 to 1-19, two-stage strengthening (chemical strengthening treatment) was performed using the crystallized glass of Example 1 under the strengthening conditions shown in Tables 2 to 5.

In Comparative Examples 1-1 and 2-1, one-stage strengthening (chemical strengthening treatment) was performed using the crystallized glass of each of Comparative Examples 1 and 2 under the strengthening conditions shown in Table 6.

For example, “Na single 380° C.×100 min” in Example 1-1 (first stage of chemical strengthening) in Table 2 indicates that the crystallized glass was immersed in a single bath of a sodium salt at 380° C. for 100 minutes.

For example, “K:Na:Li=70:1:0.05 400° C.×300 min” in Example 1-2 (second stage of chemical strengthening) in Table 2 indicates that the crystallized glass was immersed in a mixed bath, which is obtained by mixing a potassium salt, a sodium salt, and a lithium salt at a mass ratio of potassium salt:sodium salt:lithium salt=70:1:0.05, at 400° C. for 300 minutes.

TABLE 1

| | | | | Comparative | Comparative |
|---|---|---|---|---|---|
| | | | Example 1 | Example 1 | Example 2 |
| Composition | SiO₂ | | 64.81 | 75.50 | 54.56 |
| [mass. %] | Al₂O₃ | | 12.72 | 7.60 | 17.99 |
| | B₂O₃ | | 2.00 | | |
| | P₂O₅ | | 2.14 | 1.90 | |
| | Li₂O | | 7.13 | 9.60 | |
| | Na₂O | | 0.50 | | 11.59 |
| | K₂O | | 0.73 | 1.00 | 2.40 |
| | MgO | | 1.02 | 1.00 | 7.83 |
| | CaO | | 0.41 | | 0.85 |
| | SrO | | | | |
| | BaO | | | | |
| | ZnO | | 2.88 | 0.50 | |
| | ZrO₂ | | 5.60 | 2.40 | |
| | Nb₂O₅ | | | | |
| | Ta₂O₅ | | | | |
| | TiO₂ | | | | 4.70 |
| | Sb₂O₃ | | 0.06 | 0.50 | 0.08 |
| | Total | | 100.00 | 100.00 | 100.00 |
| | SiO₂ + Li₂O + Al₂O₃ + B₂O₃ | | 86.66 | 92.70 | 72.55 |
| | SiO₂/(B₂O₃ + Li₂O) | | 7.10 | 7.86 | — |
| | Al₂O₃ + ZrO₂ | | 18.32 | 10.00 | 17.99 |
| Crystallization | Nucleation | Temperature [° C.] | 600 | 560 | — |
| condition | | Retention time [h] | 5 | 10 | — |
| | Crystal | Temperature [° C.] | 660 | 740 | 705 |
| | growth | Retention time [h] | 5 | 4 | 5 |

| | | | |
|---|---|---|---|
| Tg [° C.] | 579 | — | — |

### 2. Evaluation of Inorganic Composition Article

For the obtained strengthened crystallized glass substrate, the following properties were measured, and a sandpaper falling ball test was performed. The results are shown in Tables 2 to 6.

### (1) Measurement of DOLzero and CT

A photoelastic constant (β) was determined by polishing opposing sides of a sample shape to form a disk having a diameter of 25 mm and a thickness of 8 mm, applying a compressive load in a predetermined direction, and measuring an optical path difference occurring in a center of the glass, and using the relational expression δ=β·d·F. In the relational expression, the optical path difference is expressed as δ (nm), the glass thickness is expressed as d (mm), and the stress is expressed as F (MPa).

The depth DOLzero (μm) and the central tensile stress (CT) when the compressive stress of the compressive stress layer is 0 MPa were measured using a scattered light photoelastic stress meter (“SLP-1000” manufactured by Orihara Manufacturing Co., LTD.). A light source having a wavelength of 518 nm was used as a measurement light source.

A refractive index value at a wavelength of 518 nm was calculated by using a quadratic approximation expression from the measured values of the refractive index at wavelengths of C-line, d-line, F-line, and g-line according to the V-block method specified in JIS B 7071-2:2018.

The “thickness” shown in Tables 2 to 6 is the thickness (μm) of the chemically strengthened crystallized glass substrate, and the “DOLzero/thickness” shown in Tables 2 to 6 is a value obtained by dividing DOLzero (μm) by the thickness (μm) of the chemically strengthened crystallized glass substrate.

The photoelastic constant at a wavelength of 518 nm used in the measurement of DOLzero and CT can be calculated by using a quadratic approximation expression from the measured values of the photoelastic constants at a wavelength of 435.8 nm, a wavelength of 546.1 nm, and a wavelength of 643.9 nm. In Examples 1-1 to 1-19, 30.1 was used. In Comparative Example 1-1, 28.8 was used. In Comparative Example 2-1, 28.9 was used.

### (2) Sandpaper Falling Ball Test

For the crystallized glass substrate, the sandpaper falling ball test was performed by the following method.

A sandpaper having a roughness #180 was laid on a stainless-steel base, and a crystallized glass substrate having a length of 150 mm and a width of 73 mm was placed thereon. Then, an iron ball having a diameter of φ6 mm and a mass of 0.87 g was dropped from a height of 10 cm above the center of the crystallized glass substrate to collide with the crystallized glass substrate. If the crystallized glass substrate was not broken, the height in which the iron ball was dropped was increased by 10 cm, and the same test was continued until the crystallized glass substrate was broken. After breakage, the state of the broken pieces was observed. The height when the crystallized glass substrate was broken and cracked is shown in Tables 2 to 6.

Ten broken pieces of the crystallized glass substrate after breakage were selected from large broken pieces, and the weight of each broken piece was measured. The volume of each broken piece was determined from the specific gravity 2.48 of the substrate and divided by the sheet thickness to determine the surface area of each broken piece. Using this surface area, the state of the broken pieces (how to crack) was evaluated according to the following criteria. The results are shown in Tables 2 to 6.
◯: The number of broken pieces of 1 cm² or more was 4 or more, the number of broken pieces of 10 cm² or more was 1 or more
Δ: The number of broken pieces of 1 cm² or more was 1 to 3
x: The number of broken pieces of 1 cm² or more was 0 (all the broken pieces were fine broken pieces of less than 1 cm²)

From Tables 2 to 6, it is found that the substrate of the present invention is hard and is less likely to be broken, and if the substrate is broken, the substrate is less likely to be broken into small pieces.

TABLE 2

| | Example 1-1 | Example 1-2 | Example 1-3 | Example 1-4 | Example 1-5 |
|---|---|---|---|---|---|
| Thickness | 0.6 | 0.6 | 0.6 | 0.6 | 0.6 |
| (mm) | | | | | |
| DOLzero | 101 | 114 | 93 | 98 | 107 |
| (μm) | | | | | |
| DOLzero/thickness | 16.8 | 19.0 | 15.5 | 16.3 | 17.8 |
| (%) | | | | | |
| CT | 105 | 108 | 102 | 106 | 109 |
| (MPa) | | | | | |
| Cracking height | 800 | 700 | 700 | 1100 | 700 |
| (mm) | | | | | |
| How to crack | ∘ | ∘ | ∘ | ∘ | ∘ |
| Chemical strengthening | Na single | Na single | Na single | Na single | Na single |
| First stage | 380° C. × 100 min | 400° C. × 100 min | 410° C. × 100 min | 410° C. × 110 min | 410° C. × 110 min |
| Chemical strengthening | K:Na = 50:1 | K:Na:Li = 70:1:0.05 | K single | K single | K single |
| Second stage | 400° C. × 180 min | 400° C. × 300 min | 400° C. × 60 min | 400° C. × 60 min | 400° C. × 120 min |

TABLE 3

| | Example 1-6 | Example 1-7 | Example 1-8 | Example 1-9 | Example 1-10 |
|---|---|---|---|---|---|
| Thickness | 0.6 | 0.6 | 0.6 | 0.6 | 0.6 |
| (mm) | | | | | |
| DOLzero | 98 | 108 | 107 | 115 | 103 |
| (μm) | | | | | |
| DOLzero/thickness | 16.3 | 18.0 | 17.8 | 19.2 | 17.2 |
| (%) | | | | | |
| CT | 106 | 110 | 107 | 109 | 101 |
| (MPa) | | | | | |
| Cracking height | 600 | 700 | 700 | 600 | 800 |
| (mm) | | | | | |
| How to crack | ∘ | ∘ | ∘ | ∘ | ∘ |
| Chemical strengthening | K:Na = 2:1 | K:Na = 2:1 | K:Na:Li = 2:1:0.06 | Na single | Na single |
| First stage | 410° C. × 110 min | 410° C. × 110 min | 450° C. × 50 min | 400° C. × 100 min | 400° C. × 100 min |
| Chemical strengthening | K single | K single | K:Na = 90:1 | K:Na = 90:1 | K:Na = 45:1 |
| Second stage | 400° C. × 60 min | 400° C. × 120 min | 400° C. × 120 min | 400° C. × 240 min | 450° C. × 40 min |

TABLE 4

| | Example 1-11 | Example 1-12 | Example 1-13 | Example 1-14 | Example 1-15 |
|---|---|---|---|---|---|
| Thickness | 0.6 | 0.6 | 0.57 | 0.62 | 0.57 |
| (mm) | | | | | |
| DOLzero | 96 | 92 | 85 | 89 | 73 |
| (μm) | | | | | |
| DOLzero/thickness | 16.0 | 15.3 | 14.9 | 14.4 | 12.8 |
| (%) | | | | | |
| CT | 110 | 107 | 90 | 85 | 83 |
| (MPa) | | | | | |
| Cracking height | 800 | 900 | 1000 | 1000 | 700 |
| (mm) | | | | | |
| How to crack | ∘ | ∘ | ∘ | ∘ | ∘ |
| Chemical strengthening | Na single | Na single | Na single | Na single | Na single |
| First stage | 400° C. × 105 min | 410° C. × 115 min | 400° C. × 90 min | 400° C. × 90 min | 400° C. × 80 min |
| Chemical strengthening | K:Na = 45:1 | K single | K single | K single | K single |
| Second stage | 450° C. × 40 min | 400° C. × 60 min | 450° C. × 30 min | 450° C. × 30 min | 400° C. × 30 min |

TABLE 5

| | Example 1-16 | Example 1-17 | Example 1-18 | Example 1-19 |
|---|---|---|---|---|
| Thickness | 0.57 | 0.6 | 0.56 | 0.6 |
| (mm) | | | | |
| DOLzero | 70 | 62 | 60 | 94 |
| (μm) | | | | |
| DOLzero/thickness | 12.2 | 10.3 | 10.7 | 15.7 |
| (%) | | | | |
| CT | 78 | 76 | 82 | 102 |
| (MPa) | | | | |
| Cracking height | 700 | 600 | 600 | 920 |
| (mm) | | | | |
| How to crack | ∘ | ∘ | ∘ | ∘ |
| Chemical strengthening | Na single | Na single | Na single | Na single |
| First stage | 400° C. × 60 min | 400° C. × 60 min | 400° C. × 80 min | 420° C. × 90 min |
| Chemical strengthening | K single | K:Na = 50:1 | K:Na = 50:1 | K single |
| Second stage | 400° C. × 30 min | 400° C. × 30 min | 400° C. × 30 min | 400° C. × 60 min |

TABLE 6

| | Comparative | Comparative |
|---|---|---|
| | Example 1-1 | Example 2-1 |
| Thickness | 0.55 | 0.64 |
| (mm) | | |
| DOLzero | 88 | 67 |
| (μm) | | |
| DOLzero/thickness | 16.0 | 10.5 |
| (%) | | |
| CT | 58 | 136 |
| (MPa) | | |
| Cracking height | 500 | 1200 |
| (mm) | | |
| How to crack | ∘ | x |
| Chemical strengthening | Na single | K single |
| First stage | 450° C. × 480 min | 510° C. × 500 min |
| Chemical strengthening | — | — |
| Second stage | | |

Although several embodiments and/or examples of the present invention have been described in detail above, those skilled in the art will readily be able to make many modifications to these illustrative embodiments and/or examples without substantially departing from the novel teachings and advantageous effects of the present invention. Therefore, many of these modifications fall within the scope of the present invention.

The entirety of contents of all documents cited in this specification and of the application on which priority under the Paris Convention of the present application is based are incorporated herein.

1. An inorganic composition article comprising,
as a main crystal phase, one or more selected from α-cristobalite and an α-cristobalite solid solution, wherein,
the inorganic composition article is obtained by strengthening a crystallized glass,
a thickness (DOLzero) of a compressive stress layer on the surface is 8.0% to 25.0% of a sheet thickness of the inorganic composition article,
a central tensile stress (CT) is 70 MPa to 120 MPa, and
in the crystallized glass, in mass % in terms of oxides,
a content of a SiO₂ component is 50.0% to 75.0%,
a content of a Li₂O component is 3.0% to 10.0%,
a content of an Al₂O₃ component is 5.0% or more and less than 15.0%,
a content of a B₂O₃ component is more than 0% and 10.0% or less,
a content of a P₂O₅ component is more than 0% and 10.0% or less, and
a mass ratio SiO₂/(B₂O₃+Li₂O) is 3.0 to 10.0.

2. An inorganic composition article comprising,
as a main crystal phase, one or more selected from α-cristobalite and an α-cristobalite solid solution, wherein,
the inorganic composition article is obtained by strengthening a crystallized glass,
a thickness (DOLzero) of a compressive stress layer on the surface is 8.0 μm to 500 μm,
a central tensile stress (CT) is 70 MPa to 120 MPa, and
in the crystallized glass, in mass % in terms of oxides,
a content of a SiO₂ component is 50.0% to 75.0%,
a content of a Li₂O component is 3.0% to 10.0%,
a content of an Al₂O₃ component is 5.0% or more and less than 15.0%,
a content of a B₂O₃ component is more than 0% and 10.0% or less,
a content of a P₂O₅ component is more than 0% and 10.0% or less, and
a mass ratio SiO₂/(B₂O₃+Li₂O) is 3.0 to 10.0.

3. The inorganic composition article according to claim 1, wherein
in the crystallized glass, in mass % in terms of oxides,
a content of a ZrO₂ component is more than 0% and 10.0% or less, and
a total content of the Al₂O₃ component and the ZrO₂ component is 10.0% or more.

4. The inorganic composition article according to claim 1, wherein
in the crystallized glass, in mass % in terms of oxides,
a content of a K₂O component is 0% to 5.0%.

5. The inorganic composition article according to claim 1, wherein
in the crystallized glass, in mass % in terms of oxides,
a content of a Na₂O component is 0% to 4.0%,
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

6. The inorganic composition article according to claim 1, wherein
in the crystallized glass, in mass % in terms of oxides,
a content of a Nb₂O₅ component is 0% to 5.0%,
a content of a Ta₂O₅ component is 0% to 6.0%, and
a content of a TiO₂ component is 0% or more and less than 1.0%.

7. The inorganic composition article according to claim 1, wherein a glass transition temperature (Tg) of glass before crystallization of the crystallized glass is 610° C. or lower.

8. The inorganic composition article according to claim 1, wherein the sheet thickness of the inorganic composition article is 0.1 mm to 2.0 mm.
